(19) United States
(12) Patent Application Publication
(10) Pub. No.: US 2022/0339648 A1
(43) Pub. Date: Oct. 27, 2022

(54) HIGH PRESSURE WATER JET GUN

(71) Applicant: TECOMEC S.R.L., 42124 REGGIO EMILIA (RE) (IT)

(72) Inventor: ENRICO CIGARINI, REGGIO EMILIA (IT)

(21) Appl. No.: 17/645,471

(22) Filed: Dec. 22, 2021

(30) Foreign Application Priority Data
Apr. 21, 2021 (IT) 102021000010070

(51) Int. Cl. B05B 9/01; B08B 3/02; B05B 9/03

(52) U.S. Cl. CPC B05B 9/01; B08B 3/026; B05B 9/03; B08B 2203/0282

(57) ABSTRACT

High pressure water jet gun comprising: a dispensing body (6); a gripping body (13) connected to the dispensing body (6); an actuation member (10) reversibly movable between an activation position, wherein it is active on a shutter member (9) in order to at least partly cause an open condition, and a rest position, corresponding to a closed configuration of the shutter member (9); a blocking means (15) reversibly movable between a safety configuration, in which it is active on the actuation member (10) to prevent a passage from the rest position to the activation position, and a working configuration, wherein it enables a reversible passage of the actuation member (10) between the rest position and the activation position. In particular, the blocking means (15) comprises a manual activation element (21) at least partially opposed to the gripping body (13) with respect to the dispensing body (6). The actuation member (10) and the activation element (21) are arranged on opposed portions of the dispensing body (6) so that a single hand of the user can act on the activation element (21) with the thumb and on the actuation member (10) with at least another finger of the same hand.

The present invention relates to a high pressure water jet gun. The definition “high pressure water jet” refers herein to a machine which, through the generation of a water jet at high pressure, enables the removal of incrustations and impurities from surfaces of various kinds thanks to the high impact energy on the surface.

A high pressure water jet machine generally comprises a high pressure water pump, an electric motor and a gun for dispensing the water jet.

In particular, the high pressure imparted to the water jet results in the high kinetic energy thereof which enables the jet to easily remove the impurities present on the surface to be cleaned.

Disadvantageously, the kinetic energy imparted to the jet is so high that, if it hits a person's body, it can cause injuries of varying severity.

Therefore, safety systems have been developed which aim to prevent the involuntary action of the gun for dispensing the water jet.

Disadvantageously, such systems require the use of both hands for activating the gun.

In particular, the user grips the gun with one hand and with the other hand deactivates the safety system so as to enable the dispensing of the fluid. However, during use of the gun the user grips the gun with a first hand and with a second hand holds a portion of the gun proximal to the fluid dispensing nozzle so as to be able to spread the force exerted by the jet between both limbs and so as to be able to appropriately direct the jet of fluid towards the surface to be cleaned.

Therefore, the interface with the safety system is particularly inconvenient for the user who must move his/her second hand from the portion of gun proximal to the dispensing nozzle losing accuracy in the fluid dispensing direction during the moments following the deactivation of the safety system and strongly straining the hand gripping the gun.

In this context, the technical task underpinning the present invention is to provide a high pressure water jet gun which obviates the drawbacks in the prior art as described above.

In particular, it is an object of the present invention to provide a high pressure water jet gun that enables the use of a high pressure water jet machine to be simplified for a user.

A further aim of the present invention is to provide a high pressure water jet gun that has improved ergonomics with respect to prior-art devices. A further object of the present invention is that of providing a high pressure water jet gun able to ensure a high degree of safety for the user during the different operating conditions.

The stated technical task and specified objects are substantially achieved by a high pressure water jet gun comprising the technical features disclosed in one or more of the appended claims.

The dependent claims correspond to possible embodiments of the invention.

Further features and advantages of the present invention will become more apparent from the following indicative and therefore non-limiting description of a preferred but not exclusive embodiment of a high pressure water jet gun as illustrated in the appended drawings in which:

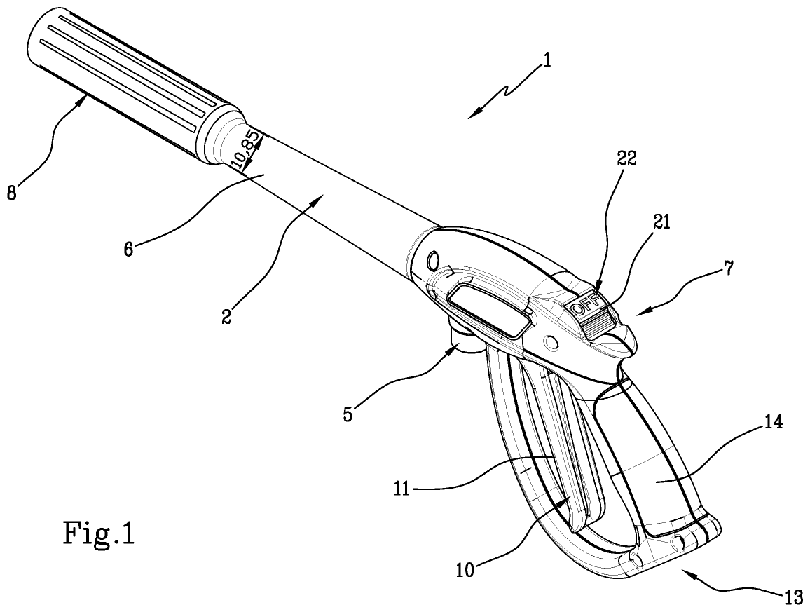

FIG. 1 is a perspective view of a high pressure water jet gun in accordance with a possible embodiment of the present invention;

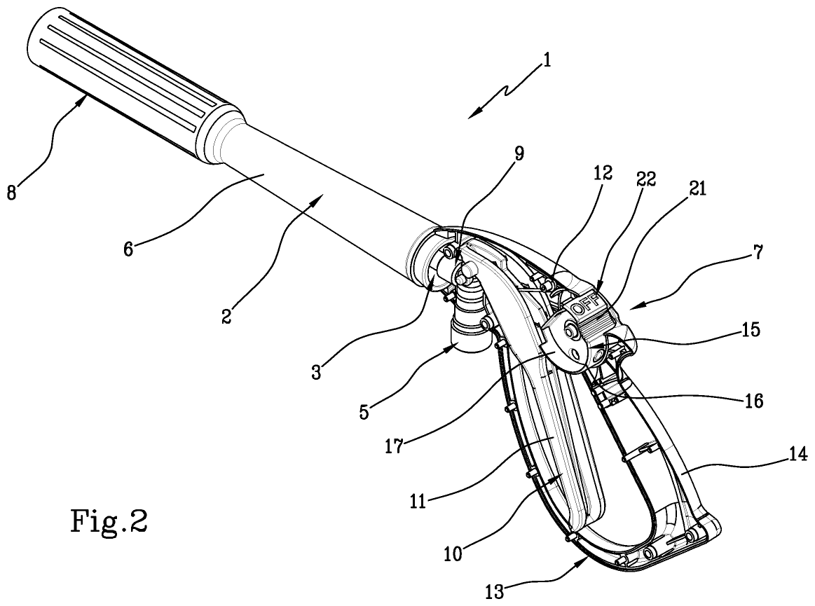

FIG. 2 is a perspective view of a portion of the high pressure water jet gun of FIG. 1;

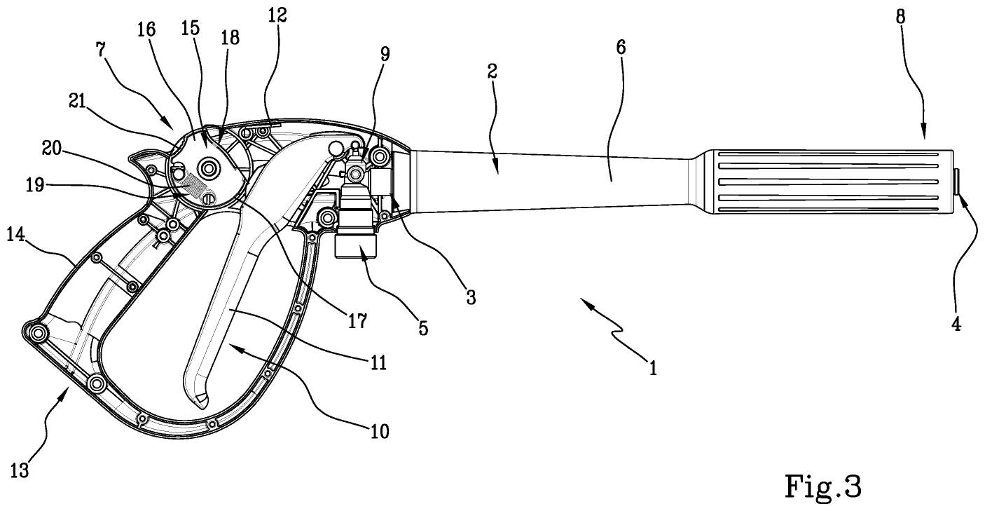

FIG. 3 is a side view of a portion of the high pressure water jet gun of FIG. 1.

With reference to the accompanying drawings, the reference number 1 has been used to generally designate a high pressure water jet gun, which will be referred to here as gun 1.

The gun 1 defines at least one conduit 2 extending between an inlet opening 3 and an outlet opening 4 in order to enable passage of at least one fluid, preferably water.

The gun 1 comprises at least one connector 5 adapted to place the inlet opening 3 in fluid communication with an external supply unit (not illustrated in the appended figures).

Furthermore, the gun 1 comprises a dispensing body 6 at least partially defining the conduit 2.

The dispensing body 6 has at least the aforementioned outlet opening 4 to enable the dispensing of the aforesaid fluid.

Preferably, the dispensing body 6 has a substantially tubular conformation extending between a first end 7 and a second end 8 along a main extension axis.

In accordance with a possible embodiment and as shown in the appended figures, the outlet opening 4 may be arranged at the second end 8. Furthermore, the inlet opening 3 can be arranged in a portion of the dispensing body 6 comprised between the first end 7 and the second end 8.

According to further possible embodiments not illustrated in the appended figures, the inlet opening 3 and/or the outlet opening 4 may be located in a different way from what has been previously described without altering the inventive concept underpinning the present invention.

The gun 1 further comprises a shutter member 9 adapted to enable or inhibit a passage of the fluid through the conduit 2.

In particular, the shutter member 9 is reversibly movable between an open condition, wherein it enables passage of the fluid through the conduit 2, and a closed condition, wherein it inhibits passage of the fluid through the conduit 2.

In other words, the shutter member 9 enables the gun 1 to dispense fluid during the opening condition and prohibits it during the closed condition. As illustrated in the appended figures, the gun 1 further comprises an actuation member 10 reversibly movable between an activation position, wherein it is active on the shutter member 9 in order to at least partly cause an open condition of the shutter member 9, and a rest position, corresponding to a closed condition of the shutter member 9.

Preferably, the actuation member 10 comprises an actuation lever 11 activatable by a user to reversibly switch the actuation member 10 between the rest position and the actuation position. Furthermore, the gun 1 can comprise at least one elastic body 12 active on the actuation member 10 to promote a movement from the actuation position to the rest position.

The gun 1 further comprises a gripping body 13 connected to the dispensing body 6.

The gripping body 13 defines a grip 14 adapted to be gripped by a user to enable a movement of the gun 1 during at least one operating configuration.

Advantageously, the gun 1 comprises a blocking means 15 which enables the level of safety during use of the gun 1 to be increased.

The blocking means 15 is reversibly movable between a safety configuration, in which it is active on the actuation member 10 to prevent a passage of the actuation member 10 from the rest position to the activation position, and a working configuration, wherein it enables a reversible passage of the actuation member 10 between the rest position and the activation position.

Preferably, the blocking means 15 can be rotatably moved between the working configuration and the safety configuration.

In accordance with a possible embodiment and as shown in the appended figures, the blocking means 15 can comprise a blocking body 16 hinged to the dispensing body 6.

The blocking body 16 defines an abutment portion 17 adapted to be activated on the actuation member 10 to prevent a passage thereof from the rest position to the activation position.

Furthermore, the blocking body 16 is reversibly rotatable between an active position, wherein the abutment portion 17 is active on the actuation member 10 defining the safety configuration of the blocking means 15, and a non-active position, wherein the abutment portion 17 is not active on the actuation member 10 defining the working configuration of the blocking means 15.

According to a possible embodiment and as illustrated in the appended figures, the blocking body 15 has a substantially cylindrical conformation, partially defining the abutment portion 17.

Furthermore, the blocking body 16 defines at least one concavity 18.

In particular, the concavity 18 is adapted to be arranged at the actuation member 10 for defining the non-active position of the blocking body 16.

Preferably, the concavity 18 is defined by a portion of a circular segment and/or a portion of a circular sector of the blocking body 16 with reference to the substantially cylindrical conformation of the blocking body 16.

Advantageously, the gun 1 can comprise at least one elastic return means 19 active on the blocking means 16 to promote a movement thereof from the working configuration to the safety configuration.

In this way, the blocking means 15 can return to the safety configuration after use of the gun 1 without any need for the intervention of the user.

According to a purely exemplifying and non-limiting embodiment of the present invention, the elastic return means 19 comprises a helix spring 20 connected to the blocking body 16 and to the dispensing body 6.

Such helix spring 20 is active on the blocking body 16 and on the dispensing body 6 to promote a movement of the blocking body 16 from the non-active position to the active position.

The blocking means 15 comprises a manual activation element 21 activatable by a user for reversibly switching the blocking means 15 between the safety configuration and the working configuration.

According to a possible embodiment illustrated in the appended figures, the activation element 21 is defined by a recessed notch, with a concave profile, with respect to the external circumferential progression of the blocking body 15 having a substantially cylindrical conformation.

Advantageously, the actuation member 10 and the activation element 21 are arranged on opposed portions of the dispensing body 6 so that during normal use of the gun 1, a single hand of a user can act on the activation element 21 with the thumb and on the actuation member 10 with at least another finger of the same hand.

In this way, the invention provides a gun with improved ergonomics with respect to prior art devices.

Furthermore, the gun 1 enables the use of a high pressure water jet machine for a user to be simplified enabling the dispensing of the fluid following activation through the use of only one hand.

Furthermore, in this way, the gun 1 can be constantly supported by the other hand so as to guarantee precise pointing of the jet.

Preferably, the activation element 21 and the actuation member 10 are arranged so that, when the gripping body 13 is facing downwards, the activation element 21 is facing upwards.

In particular, the activation element 21 can be arranged in a top portion of the dispensing body 6.

Furthermore, advantageously, the activation element 21 can be at least partially opposed to the gripping body 13 with respect to the dispensing body 6.

In this way, the user can activate the activation element 21 with the thumb of the same hand that is holding the gripping body 13 of the gun 1.

In other words, the user can activate the activation element by pushing the thumb of the same hand that is holding the gripping body 13 above the recessed notch defined by the activation element 21. These particular ergonomics make the activation and deactivation of the element 21 very effective, especially when the user is wearing very thick protective gloves and overalls which penalise the movements of the user's limbs.

According to a possible embodiment and as illustrated in the appended figures, the activation element 21 is made as a single piece with the blocking body 16 simplifying the manufacturing process of the gun 1.

Furthermore, in this way, the user can activate the activation element 21 by placing it in rotation with a thumb. Such rotation determines the rotation of the blocking body 16 which can, therefore, pass from the active position to the non-active position to enable the dispensing of the fluid by the gun 1.

Preferably, the gun 1 further comprises indicator means 22 adapted to indicate to a user whether the blocking means 15 is arranged in the safety configuration and/or in the working configuration.

In accordance with a possible embodiment and as shown in the appended figures, the indicator means 22 can be arranged on the blocking body 16 of the gun 1.

In this way, the user can activate the activation element 21 with high safety and aware of the operating configuration of the blocking means 15. It is therefore observed that the present invention achieves the proposed aims by providing a high pressure water jet gun able to simplify the use of a high pressure water jet for a user thanks to the presence of an activation element arranged so that, during normal use of the gun, a single hand of a user can act on the activation element with the thumb and on the actuation member with at least another finger of the same hand.

Advantageously, the present invention makes available a gun with improved ergonomics with respect to devices of the prior art such as to make the use of the high pressure water jet simpler and less tiring for a user.

1. A high pressure water jet gun defining at least one conduit (2) extending between an inlet opening (3) and an outlet opening (4) in order to enable passage of at least one fluid and comprising:
at least one connector (5) adapted to place said inlet opening (3) in fluid communication with an external supply unit;
a dispensing body (6) at least partly defining said conduit (2) and having at least said outlet opening (4) to enable a dispensing of the fluid;
a gripping body (13) connected to said dispensing body (6) and defining a grip (14), said grip (14) being configured to be gripped by a user to enable a movement of said gun (1) during at least one operating configuration;
a shutter member (9) to enable or inhibit a passage of the fluid through said conduit (2), said shutter member (9) being reversibly movable between an open condition, wherein it enables passage of the fluid through said conduit (2), and a closed configuration, wherein it inhibits passage of the fluid through said conduit (2);
an actuation member (10) reversibly movable between an activation position, wherein said actuation member (10) is active on said shutter member (9) in order to at least partly cause an open condition of said shutter member (9), and a rest position, corresponding to a closed configuration of said shutter member (9);
a blocking means (15) reversibly movable between a safety configuration, in which the blocking means (15) is active on said actuation member (10) to prevent a passage of said actuation member (10) from said rest position to said activation position, and a working configuration, wherein the blocking means (15) enables a reversible passage of said actuation member (10) between said rest position and said activation position;
wherein said blocking means (15) comprise a manual activation element (21) activatable by a user so as to reversibly switch said blocking means (15) between said safety configuration and said working configuration, said activation element (21) being at least partly opposed to said gripping body (13) with respect to said dispensing body (6);
and wherein said actuation member (10) and said activation element (21) are arranged on opposed portions of the dispensing body (6) so that during a normal use of the gun (1), a single hand of a user can act on said activation element (21) with the thumb and on the actuation member (10) with at least another finger of the same hand.

2. The high pressure water jet gun according to claim 1, wherein said activating member (21) and said actuation element (10) are arranged in such a way that, when the gripping body (13) is facing downwards, said activation element (21) is facing upwards, said activation element (21) preferably being arranged in a top portion of the dispensing body (6).

3. The high pressure water jet gun according to claim 1, wherein said blocking means (15) is reversible rotatably movable between said safety configuration and said working configuration.

4. The high pressure water jet gun according to claim 1, wherein said blocking means (15) comprises a blocking body (16) pivoted to said dispensing body (6) and defining an abutment portion (17) adapted to be activated on said actuation member (10) to prevent a passage thereof from said rest position to said activation position; and wherein said blocking body (16) is reversibly rotatable between an active position, wherein said abutment portion (17) is active on said actuation member (10) defining said safety configuration of said blocking means (15), between a non-active position, wherein said abutment portion (17) is not active on said actuation member (10) defining said working configuration of said blocking means (15).

5. The high pressure water jet gun according to claim 4, wherein said blocking body (16) has a substantially cylindrical conformation, at least partly defining said abutment portion (17), and defines at least one concavity (18); and wherein said concavity (18) is adapted to be arranged at said actuation member (10) to define said non-active position of said blocking body (16).

6. The high pressure water jet gun according to claim 5, wherein said concavity (18) is defined by a portion of a circular segment and/or by a portion of a circular sector of said substantially cylindrical conformation of said blocking body (16).

7. The high pressure water jet gun according to claim 1, comprising elastic return means (19) active on said blocking means (15) to cause a movement of said blocking means (15) from said working configuration to said safety configuration.

8. The high pressure water jet gun according to claim 4, comprising elastic return means (19) active on said blocking means (15) to cause a movement of said blocking means (15) from said working configuration to said safety configuration, wherein said elastic return means (19) comprises a helix spring (20) connected to said blocking body (16) and to said dispensing body (6) and active on said blocking body (16) and said dispensing body (6) to cause a movement of said blocking body (16) from said non-active position to said active position.

9. The high pressure water jet gun according to claim 1, wherein said actuation member (10) comprises an actuation lever (11) activatable by a user to reversibly move said actuation member (10) between said rest position and said actuation position.

10. The high pressure water jet gun according to claim 1, comprising at least one elastic body (12) active on said actuation member (10) to cause a movement of said actuation member (10) from said actuation position to said rest position.

11. The high pressure water jet gun according to claim 1, comprising indicator means (22) adapted to indicate to a user said safety configuration and/or said working configuration of said blocking means (15).

12. The high pressure water jet gun according to claim 4, comprising indicator means (22) adapted to indicate to a user said safety configuration and/or said working configuration of said blocking means (15), wherein said indicator means (22) is arranged on said blocking body (16).

13. The high pressure water jet gun according to claim 5, wherein said activation element (21) is defined by a recessed notch, with a concave profile, with respect to the external circumferential progression of the blocking body (15) having a substantially cylindrical conformation.
